(19) United States
(12) Patent Application Publication
(10) Pub. No.: US 2012/0278055 A1
(43) Pub. Date: Nov. 1, 2012

(54) MOTION CORRECTION IN RADIATION THERAPY

(75) Inventors: Bernd Schweizer, Herzogenrath (DE); Andreas Goedicke, Aachen (DE)

(73) Assignee: KONINKLIJKE PHILIPS ELECTRONICS N.V., EINDHOVEN (NL)

(21) Appl. No.: 13/503,933

(22) PCT Filed: Oct. 14, 2010
(86) PCT No.: PCT/IB2010/054665

§ 371 Date: Apr. 25, 2012

Related U.S. Application Data
(60) Provisional application No. 61/262,172, filed on Nov. 18, 2009.

(51) Int. Cl. G06G 7/48

(52) U.S. Cl. 703/11

(57) ABSTRACT

A diagnostic imaging system includes a tomographic scanner 10 which generates sets of anatomical and functional image data. An adaption unit 50 adapts a motion model to a geometry of an object of interest based on a motion averaged volume image representation acquired over a plurality of motion phases. Virtual image data is simulated from the anatomical projection image data with the motion model at the plurality of motion phases. A comparison unit 54 determines a difference between the actual and virtual anatomical image data. If the difference meets a stopping criterion, the motion model is used to correct acquired functional image data, and a corrected functional image is reconstructed therefrom. If not, the motion model is iteratively updated based until the difference meets the stopping criterion.

The present application relates to the diagnostic imaging arts. It finds particular application in conjunction with combined x-ray computed tomography (CT) scanners and emission tomography scanners such as positron emission tomography (PET) and single photon emission computed tomography (SPECT).

In diagnostic nuclear imaging, a radionuclide distribution is studied as it passes through a patient's bloodstream for imaging the circulatory system or for imaging specific organs that accumulate the injected radiopharmaceutical. In single-photon emission computed tomography (SPECT), one or more radiation detectors, commonly called gamma cameras, are used to detect the radiopharmaceutical via radiation emission caused by radioactive decay events. Typically, each gamma camera includes a radiation detector array and a honeycomb collimator disposed in front of the radiation detector array. The honeycomb collimator defines a linear or small-angle conical line of sight so that the detected radiation comprises projection data. If the gamma cameras are moved over a range of angular views, for example over a 180° or 360° angular range, then the resulting projection data can be reconstructed using filtered back-projection, expectation-maximization, or another imaging technique into an image of the radiopharmaceutical distribution in the patient. Advantageously, the radiopharmaceutical can be designed to concentrate in selected tissues to provide preferential imaging of those selected tissues.

In positron emission tomography (PET), the radioactive decay events of the radiopharmaceutical produce positrons. Each positron interacts with an electron to produce a positron-electron annihilation event that emits two oppositely directed gamma rays. Using coincidence detection circuitry, a ring array of radiation detectors surrounding the imaging patient detect the coincident oppositely directed gamma ray events corresponding to the positron-electron annihilation. A line of response (LOR) connecting the two coincident detections contains the position of the positron-electron annihilation event. Such lines of response are analogous to projection data and can be reconstructed to produce a two- or three-dimensional image. In time-of-flight PET (TOF-PET), the small time difference between the detection of the two coincident y ray events is used to localize the annihilation event along the LOR (line of response).

One problem with both SPECT and PET imaging techniques is that the photon absorption and scatter by the anatomy of the patient between the radionuclide and the detector distorts the resultant image. In order to obtain more accurate nuclear images, a direct transmission radiation measurement is made using transmission computed tomography techniques. The transmission data is used to construct an attenuation map of density differences throughout the body and used to correct for absorption of emitted photons. In the past, a radioactive isotope line or point source was placed opposite the detector, enabling the detector to collect transmission data. The ratio of two values, when the patient is present and absent, is used to correct for non-uniform densities which can cause image noise, image artifacts, image distortion, and can mask vital features.

Another technique uses x-ray CT scan data to generate a more accurate attenuation map. Since both x-rays and gamma rays are more strongly attenuated by hard tissue, such as bone or even synthetic implants, as compared to softer tissue, the CT data can be used to estimate an attenuation map for gamma rays emitted by the radiopharmaceutical. Typically, a energy dependent scaling factor is used to convert CT pixel values, Hounsfield units (HU), to linear attenuation coefficients (LAC) at the appropriate energy of the emitted gamma rays.

In the past, nuclear and CT scanners were permanently mounted adjacent to one another in a fixed relationship and shared a common patient support. The patient was translated from the examination region of the CT scanner to the examination region of the nuclear scanner. However, due to potential movement of the patient or repositioning between the CT scanner and the nuclear scanner, this technique introduced uncertainty in the alignment between the nuclear and CT images.

To eliminate alignment problems, current systems mount the CT and nuclear imagining systems to a common gantry. However, the design implies that the speed of the gantry is limited to 10's of seconds per revolution. If the patients hold their breath during the CT acquisition, motion can be eliminated or reduced in the CT data. A problem arises in that the nuclear imaging acquisition time is longer than a breath hold to generate sufficient data. So, the patient breathes freely. The patient's geometry during the breath-hold CT scan does not match that of the free-breathing nuclear scan. This causes reconstruction artifacts because of a mismatch between the attenuation map and the emission data acquired over the several minutes during which nuclear data is acquired, especially in regions with increased motion such as the diaphragm, heart walls, or the like.

The present application provides a new and improved method and apparatus of attenuation and scatter correction of moving objects in nuclear imaging which overcomes the above-referenced problems and others.

In accordance with one aspect, a method for generating a motion model is presented. A set of anatomical projection image data is acquired during a plurality of phases of motion of an object of interest. The set of acquired anatomical projection image data is reconstructed into a motion averaged anatomical image representation. Adapting a geometry of a motion model to the geometry of the object of interest based on the motion averaged volume image representation. The anatomical projection image data from the motion averaged anatomical image representation with the motion model is simulated at the plurality of motion phases. The motion modeled is updated based on a difference between the acquired set of anatomical projection image data and the simulated anatomical projection image data.

In accordance with another aspect, a processor configured to perform the method for generating a motion model.

In accordance with another aspect, a diagnostic imaging system includes a tomographic scanner consecutively which generates sets of anatomical and functional image data. The diagnostic imaging system includes one or more processors programmed to perform the method of generating a motion model.

In accordance with another aspect, a diagnostic imaging system includes a tomographic scanner which generates sets of anatomical and functional image data of an object of interest. An anatomical reconstruction unit reconstructs the set of anatomical projection image data into a motion averaged anatomical image representation. An adaption unit adapts a motion model to the geometry of the object of interest based on the motion averaged volume image representation. A simulation unit simulates the anatomical projection image data, from the motion averaged anatomical image representation, with the motion model at the plurality of motion phases. A comparison unit determines a difference between the acquired set of anatomical projection image data and the simulated anatomical projection image data. A motion model updating unit updates the motion modeled based on the difference determined by the comparison unit.

One advantage is that image data of an object of interest can be acquired over a plurality of motion phases.

Another advantage relies in that the signal-to-noise ratio (SNR) is improve for acquiring image data of an object of interest while in motion.

Another advantage relies in that image data of an object of interest can be acquired during a gantry rotation of a tomographic scanner.

Another advantage relies in that radiation exposure to a subject is reduced during projection data acquisition.

Another advantage relies in that correction data, for correcting emission data, can be acquired for individual motion phases of an object of interest.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

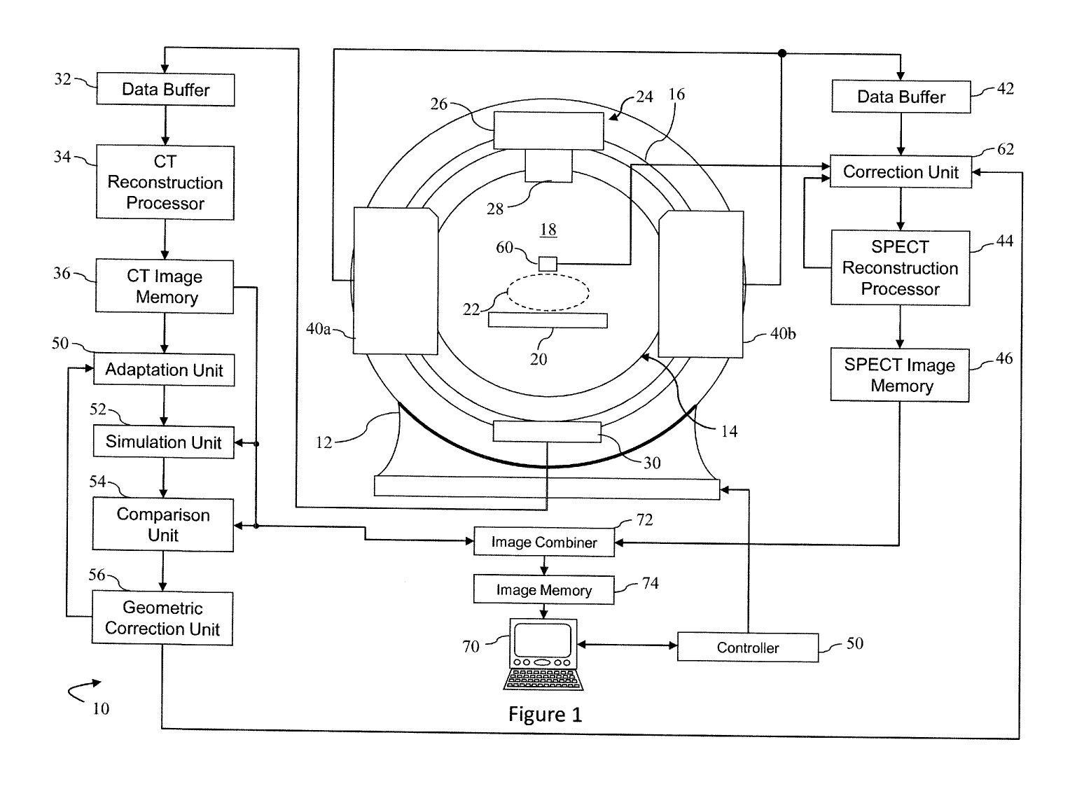

FIG. 1 is a diagrammatic view of combined SPECT/CT single gantry system with a motion modeling unit; and

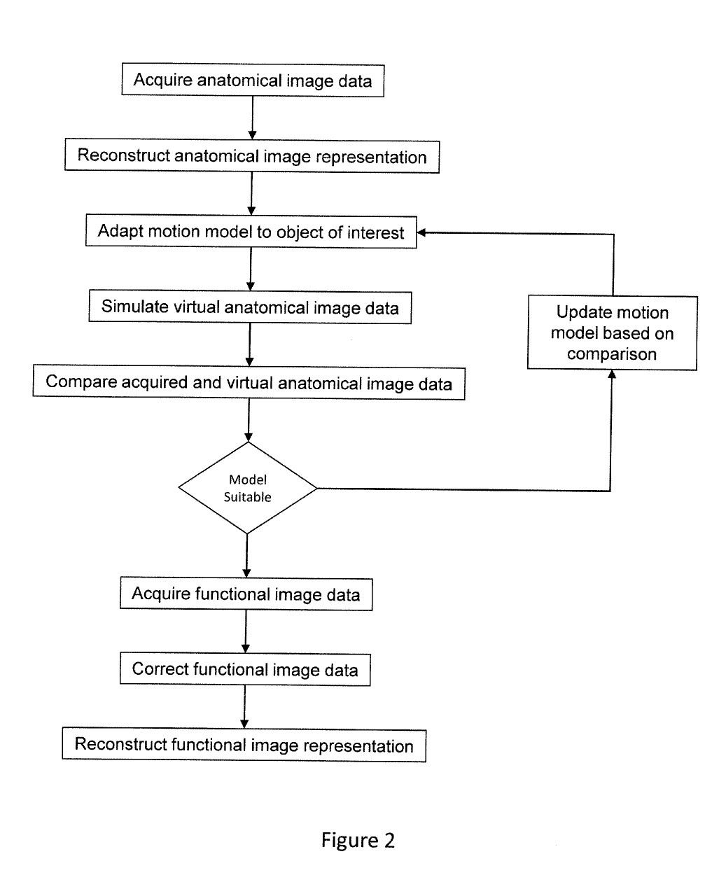

FIG. 2 is a flow chart of a method for generating a motion model.

With reference to FIG. 1, a diagnostic imaging system 10 performs concurrently and/or independently x-ray computed tomography (XCT) and nuclear imaging, such as PET or SPECT. The imaging system 10 includes a stationary housing 12 which defines a patient receiving bore 14. A rotatable gantry 16, supported by the housing 12, is arranged around the bore to define a common examination region 18. A patient support 20, which supports a patient or subject 22 to be imaged and/or examined, is longitudinally and/or vertically adjusted to achieve the desired positioning of the patient in the examination region.

To provide XCT imaging capabilities, an x-ray assembly 24 which is mounted on the rotatable gantry 16 includes an x-ray source 26, such as an x-ray tube, and a collimator or shutter assembly 28. The collimator collimates the radiation from the x-ray source 26 into a cone or wedge beam, one or more substantially parallel fan beams, or the like. The shutter gates the beam on and off. An x-ray detector 30, such as a solid state, flat panel detector, is mounted on the rotatable gantry 16 opposite the radiation assembly 24. As the gantry rotates, the x-ray assembly 24 and detector 30 revolve in concert around the examination region 18 to acquire XCT projection data spanning half revolution, a full 360° revolution, multiple revolutions, or a smaller arc. Each XCT projection indicates x-ray attenuation along a linear path between the x-ray assembly 24 and the x-ray detector 30. The acquired XCT projection data is stored in a data buffer 32 and processed by an XCT reconstruction processor 34 into a XCT image representation and then stored in a XCT image memory unit 36. Taken together, the x-ray source, the collimator/shutter assembly, the detector, and the reconstruction processor define a means for generating an anatomical image.

To provide functional nuclear imaging capabilities, at least two nuclear detector heads 40a, 40b, such as single photon emission tomography (SPECT) detectors, are moveably mounted to the rotating gantry 16. Mounting the x-ray assembly 24 and the nuclear detector heads 40a, 40b permits the examination region 18 to be imaged by both modalities without moving the patient 22. In one embodiment, the detector heads are moveably supported by robotic assembly (not shown) which is mounted to the rotating gantry 16. The robotic assembly enables the detector heads to be positioned about the patient 22 to acquire views spanning varying angular ranges, e.g. 90° offset, 180° opposite each other, etc. Each SPECT detector head includes a collimator such that each detected radiation event is known to have originated along an identifiable linear or small-angle conical line of sight so that the acquired radiation comprises projection data. The acquired SPECT projection data is stored in a data buffer 42 and processed by a SPECT reconstruction processor 44 into a SPECT image representation and then stored in a SPECT image memory unit 46. Taken together, the SPECT detector heads and the SPECT reconstruction processor define a means for generating a functional image.

In another embodiment, the functional imaging means includes positron emission tomography (PET) detectors. One or more rings of PET detectors are arranged about the patient receiving bore 14 to receive gamma radiation therefrom. Detected pairs of coincident radiation events define PET projection data which is stored in a data buffer and processed by a PET reconstruction processor into a PET image representation and then stored in a PET image memory unit. Taken together, the PET detector ring(s) and the PET reconstruction processor define the means for generating the functional image.

Typically, in functional nuclear imaging an attenuation map is generated from transmission data of the subject. The attenuation map acts to correct the acquired functional projection data for attenuation, i.e. photons which otherwise would have been included in the functional image, resulting in image variations due to tissue of greater density absorbing more of the emitted photons. In multi-gantry systems, the transmission data is acquired from the anatomical imaging system during a breath hold acquisition. The subject is then repositioned into functional imaging system which typically is adjacent to the anatomical imaging system and shares the same patient support.

Even when the two imaging systems are in close proximity to one another, repositioning errors can occur which reduce the accuracy of the attenuation map. Furthermore, the functional imaging time is sufficiently long that it lasts several breathing cycles. On the other hand, the anatomical image can be generated in a sufficiently short time that it can be generated during a single breath hold. However, because the functional image data is generated over the entire range of breathing phases; whereas, the anatomical image data is generated in a single breathing phase, the anatomical and functional image representations do not match in all respiratory phases. This leads to image artifacts. To overcome these problems, a motion model of an object of interest is generated from anatomical image data. An attenuation map for each phase of motion of the object of interest is generated using the motion model.

Continuing with reference to FIG. 1, the diagnostic imaging scanner is operated by a controller 50 to perform an imaging sequence. After the subject is positioned in the examination region 18, the imaging sequence acquires a set of anatomical projection imaging data of an object of interest at a plurality of projection angles by making use of the anatomical image generation means while the object undergoes a plurality of phases of respiratory or other motion, e.g. undergoes a respiratory cycle. The acquired set of anatomical image projection data is stored in a data buffer 32. An anatomical reconstruction processor 34 reconstructs at least one motion averaged anatomical volume representation from the acquired set of anatomical projection image data. The reconstructed motion averaged anatomical volume representation(s) is stored in an anatomical image memory 36. Since the anatomical image projection data is acquired during a plurality of the motion phases, the resultant motion averaged volume representation is a blurred image of the object of interest. For example, if the object of interest is a tumor located in one of the lungs, it will undergo periodic motion due to breathing. Unlike a breath-hold imaging sequence in which a gantry rotates to collect a full set of data in a single breath-hold, the present arrangement allows a subject to breathe freely during acquisition to accommodate a gantry 16 in which a single rotation is longer than a typical breath hold.

From the motion averaged volume representation, the blurred surface or boundary of the object of interest is indicative of motion phases of the object of interest. Therefore, an adaptation unit 50, which defines a means for adaptation, automatically or semi-automatically adapts a motion model to the geometry of the object of interest based on the motion averaged volume representation. The adaptation unit includes a library of generic motion models, e.g. Non-uniform rational basis spline (NURBS) based nuclear computed axial tomography (NCAT) and x-ray computer axial tomography (XCAT) computation phantoms, from which it determines a best match based on the geometry of the object of interest. The determined best match motion model is fitted to the geometry of the object of interest using known segmentation and/or fitting method, such as polygonal mesh or cloud of points (CoP) fitting schemes for three-dimensional (3D) regions, the adaptation unit determines the phases of motions of the object of interest using its blurred boundary from the motion averaged anatomical image representation, the duration of the anatomical imaging scan, and/or time stamps associated with the anatomical image projection data.

A simulation unit 52, which defines a means for simulating, generates virtual anatomical projection image data based on the motion model. Simulation methods for generating two-dimensional (2D) anatomical projection data of a 3D patient image or model are known in the field, e.g. Monte Carlo (MC) based methods including Compton and/or Rayleigh scatter modelling or the like.

A comparison unit 54, which defines a means for comparing, compares the virtual and actually acquired anatomical projection image data by generating a deformation field at each projection angle based on a difference between the virtual two-dimensional (2D) projection of the anatomical image and the actually acquired 2D anatomical projection image data at the corresponding angle in a known respiratory phase. By analyzing the difference between the virtual and the acquired anatomical images or projections, the comparison unit derives 2D deformation fields for each projection angle. The comparison can be based on a landmark based deformation calculation where two components of motion for each landmark are calculated per projection angle or a 2D elastic registration calculation which calculates a 2D deformation vector field per projection angle.

A geometric correction unit 56, which defines a means for geometric correction, combines the 2D deformation fields at all of the projection angles to form a consistent 3D deformation field. The combination performed by the geometric correction unit can be based on a maximum-likelihood (ML) movement model by deriving the most likely 3D deformation field that explains best the 2D deformations observed or a purely geometrical approach which solves for the 3D intersection of the projection lines of individual landmarks in different viewing angles. The geometric correction unit determines geometric corrections to the motion model at each motion phase in order to minimize the difference between the acquired anatomical projection image data and the simulated projection image data. The adaptation unit 50 applies the geometric correction such that the motion model is in agreement with the geometry of the object of interest.

Taken together, the adaptation unit 50, simulation unit 52, comparison unit 54, and geometric correction unit 56 define a means for generating a motion model. Generating the motion model is iteratively repeated until a preselected quality factor or stopping criterion is reached.

Once a qualifying motion model is generated, the scanner controller continues the imaging sequence to acquire a set of functional imaging data of the object of interest by making use of the functional image generation means while the object undergoes the plurality of phases of motion. Alternatively, the functional imaging data can be generated concurrently with the anatomical image projection data and stored until the 3D motion model is generated. Typically, the subject to be imaged is injected with one or more radiopharmaceutical or radioisotope tracers. Examples of such tracers are Tc-99m, Ga67, In-111, and I-123. The presence of the tracer within the object of interest produces emission radiation events from the object of interest which are detected by the nuclear detector heads 40a, 40b. The acquired set of functional image data is stored in a data buffer 42. A motion sensing device 60, which defines a means for motion sensing, generates a motion signal during acquisition of the set of functional image data. The motion signal is indicative of the current phase of motion of the object of interest while the functional image data is being acquired. Examples of a motion sensing device include a breathing belt, an optical tracking system, an electrocardiogram (ECG), pulsometer, or the like. The generated motion signal is used to bin the acquired functional image data into sets of equal patient geometry, i.e. same phase of motion.

Using the motion model from the motion model generation means and the generated motion signal, a correction unit 62, which defines a means for correcting, corrects the set of functional image data for each phase of motion of the object of interest. Examples of types of correction include attenuation correction, scatter correction, partial volume correction, or the like. To correct for attenuation, the correction unit generates an attenuation map for each motion phase of the object of interest based on the generated motion model. Each bin of functional image data is corrected using the attenuation map corresponding the motion phase associated with that bin. Accordingly, the correction unit generates a scatter correction function for each motion phase of the object of interest based on the generated motion model. Each bin of functional image data is corrected using the scatter correction function corresponding the motion phase associated with that bin. The correction unit generates a standard uptake value (SUV) correction factor for each motion phase of the object of interest based on the generated motion model. Each bin of functional image data is corrected using SUV correction factor corresponding the motion phase associated with that bin. It should be appreciated that other methods for attenuation, scatter, and partial volume correction are also contemplated.

In a more specific example, the motion model is a four-dimensional (4D) model, i.e. a stack of 3D attenuation maps for each respiratory or other motion phase. As a detector head collects data, each radiation event is coded with position on the detector head, detector head angular position, and motion phase. During reconstruction, the data is binned by motion phase and corrected using the attenuation map for the corresponding motion phase.

A functional reconstruction processor 44 reconstructs at least one functional image representation from the corrected set of functional image data. The reconstructed functional image representation(s) is stored in a functional image memory 46. A workstation or graphic user interface 70 includes a display device and a user input device which a clinician can use to select scanning sequences and protocols, display image data, and the like.

An optional image combiner 72 combines the anatomical image representation and the functional image representation into one or more combined image representations for concurrent display. For example, the images can be superimposed in different colors, the outline or features of the functional image representation can be superimposed on the anatomical image representation, the outline or features of the segmented anatomical structures of the anatomical image representation can be superimposed on the functional image representation, the functional and anatomical image representations can be displayed side by side with a common scale, or the like. The combined image(s) is stored in a combined image memory 74.

With reference to FIG. 1, the scanner controller 50 includes a processor programmed with a computer program, the computer program being stored on a computer readable medium, to perform the method according to the illustrated flowchart which may include, but not limited to, controlling the functional and anatomical imaging means, i.e. a photon emission tomography scanner and an x-ray tomography scanner. Suitable computer readable media include optical, magnetic, or solid state memory such as CD, DVD, hard disks, diskette, RAM, flash, etc.

The method, according to FIG. 2, for generating a motion model includes acquiring anatomical image data. The acquired anatomical image data is reconstructed into an anatomical image representation. A motion model is adapted to an object of interest, highlighted in the anatomical image representation. Virtual anatomical image data is generated by simulating the acquired anatomical image data with the motion model at a plurality of motion phases. The actually acquired anatomical image data is to the virtual anatomical image data. If the difference between the actual and virtual anatomical image data is below a threshold or meets a stopping criterion, the motion model is used to correct functional image data and a functional image representation is reconstructed therefrom. If the difference between the actual and virtual anatomical image data is not below the threshold or does meet the stopping criterion, the motion model is updated based on the difference and the simulation is repeated iteratively until a suitable motion model is generated.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for generating a motion model, comprising:
acquiring a set of anatomical projection image data during a plurality of phases of motion of an object of interest;
reconstructing the set of anatomical projection image data into a motion averaged anatomical volume image representation;
adapting a geometry of a motion model to the geometry of the object of interest based on the motion averaged volume image representation;
simulating the anatomical projection image data from the motion averaged anatomical image representation with the motion model at the plurality of motion phases; and
updating the motion model based on a difference between the acquired set of anatomical projection image data and the simulated anatomical image data.

2. The method according to claim 1, further including:
iteratively repeating the steps of simulating the anatomical projection image data then updating the motion model until a stopping criterion is achieved.

3. The method according to claim 1, wherein the set of anatomical projection image data is acquired at each of a plurality of projection angles.

4. The method according to claim 3, wherein the step of updating the motion modeled further includes:
generating a deformation field at each of the projection angles based on a difference between the set of anatomical projection image data and the set of simulated anatomical projection image data at a corresponding projection angle;
combining the deformation fields at each projection angle to form a three-dimensional (3D) deformation field; and
updating the geometry of the motion model based on the 3D deformation field.

5. The method according to claim 1, further including:
acquiring a set of functional image data during the plurality of phases of the motion of the object of interest;
correcting the set of functional image data based on the motion model for each phase of motion; and
reconstructing the corrected set of functional image data into at least one corrected functional image representation of the object of interest.

6. The method according to claim 5, further including:
acquiring a motion signal from a motion sensing device during acquisition of the set of functional image data, the motion signal characterizing each phase of the motion of the object of interest.

7. The method according to claim 6, wherein the step of correcting the set of functional image data further includes:
generating an attenuation map based on the 3D deformation field for each of the phases of motion according to the acquired motion signal; and
correcting the set of functional image data for attenuation and scatter according to the attenuation map for each phase of motion.

8. The method according to claim 5, further including:
acquiring a series of corresponding anatomical and functional images in each of the motion phases; and
combining the corresponding anatomical and functional images in each motion phase.

9. The method according to claim 1, wherein:
the set of anatomical projection image data is x-ray tomography projection data; and
the set of functional image data is gamma emission tomography projection data.

10. A processor configured to perform the steps of claim 1.

11. A computer readable medium carrying a computer program which controls a processor which controls a photon emission tomography scanner and an x-ray tomography scanner to perform the method of claim 1.

12. A diagnostic imaging system, comprising:
a tomographic scanner which consecutively generates sets of anatomical and functional image data; and
one or more processors programmed to perform the method steps according to claim 1.

13. A diagnostic image scanner, comprising:
a tomographic scanner which acquires a set of anatomical projection image data during a plurality of phases of motion of an object of interest;
an anatomical reconstruction unit which reconstructs the set of anatomical projection image data into a motion averaged anatomical image representation;
an adaption unit which adapts a motion model to the geometry of the object of interest based on the motion averaged volume image representation;
a simulation unit which simulates anatomical projection image data from the motion averaged anatomical image representation with the motion model at the plurality of motion phases; and
a comparison unit which determines a difference between the acquired set of anatomical projection image data and the simulated anatomical image data; and
a motion model updating unit which updates the motion modeled based on the difference determined by the comparison unit.

14. The diagnostic image scanner according to claim 10, wherein
the simulation unit iteratively repeats the simulation of the anatomical projection image data with the updated motion model until a stopping criterion is achieved.

15. The diagnostic image scanner according to claim 13, wherein the tomographic scanner acquires the set of anatomical projection image data at each projection angle once.

16. The diagnostic image scanner according claim 15, wherein:
the comparison unit generates a deformation field at each of the projection angles based on a difference between the set of anatomical projection image data and the simulated anatomical projection image data at a corresponding projection angle; and
the motion model updating unit combines the deformation fields at each projection angle to form a three-dimensional (3D) deformation field and updates the geometry of the motion model based on the 3D deformation field.

17. The diagnostic image scanner according to claim 13, wherein the tomographic scanner acquires a set of functional image data during the plurality of phases of motion of the object of interest, the diagnostic image scanner further including:
a correction unit which corrects the set of functional image data based on the motion model for each phase of motion; and
a functional reconstruction unit which reconstructs the corrected set of functional image data into at least one corrected functional image representation of the object of interest.

18. The diagnostic image scanner according to claim 17, further including:
a motion sensing device which acquires a motion signal during acquisition of the set of functional image data, the motion signal characterizing each phase of the motion of the object of interest.

19. The diagnostic image scanner according to claim 18, wherein:
the correction unit generates an attenuation map based on the 3D deformation field for each phase of motion according to the acquired motion signal; and
the correction unit corrects the set of functional image data for attenuation and scatter according to the attenuation map for each phase of motion.

20. A processor 50 for controlling a diagnostic imaging system, the processor carries a computer program on a computer readable medium which performs the method of:
reconstructing a set of acquired anatomical projection image data into a motion averaged anatomical volume image representation;
adapting a geometry of a motion model to the geometry of the object of interest based on the motion averaged volume image representation;
simulating the anatomical projection image data from the motion averaged anatomical image representation with the motion model at the plurality of motion phases; and
updating the motion model based on a difference between the acquired set of anatomical projection image data and the simulated anatomical image data.
